(19) United States
(12) Patent Application Publication
(10) Pub. No.: US 2024/0054974 A1
(43) Pub. Date: Feb. 15, 2024

(54) PULSE WIDTH MODULATED SIGNALS TO CONTROL DISPLAYS

(71) Applicant: HEWLETT-PACKARD DEVELOPMENT COMPANY, L.P., Spring, TX (US)

(72) Inventors: Chia-Cheng LIN, Taipei City (TW); Thong THAI, Spring, TX (US); Super LIAO, Taipei City (TW); Chen-Mu CHANG, Taipei City (TW)

(21) Appl. No.: 17/887,406

(22) Filed: Aug. 12, 2022

(51) Int. Cl. G09G 5/18; G09G 5/10

(52) U.S. Cl. CPC G09G 5/18; G09G 5/10; G09G 2320/0626; G09G 2310/08

(57) ABSTRACT

In examples, an electronic device comprises a bus and a microcontroller coupled to the bus. The microcontroller is to encode a pattern in a pulse width modulated (PWM) signal by manipulating a duty cycle of the PWM signal and a duration of the duty cycle and to provide the PWM signal on the bus. The electronic device comprises a display panel and a timing controller (TCON) coupled to the display panel and to the microcontroller via the bus. The TCON is to control a brightness feature and a non-brightness feature of the display panel based on the pattern encoded in the PWM signal.

### BACKGROUND

Various types of electronic devices, such as laptop computers, desktop computers, tablets, notebooks, smartphones, and televisions, have displays and components that are useful to control the displays. Such components may include, for example, timing controllers, embedded controllers (e.g., microcontrollers), graphics processing units, and central processing units.

### BRIEF DESCRIPTION OF THE DRAWINGS

Various examples will be described below referring to the following figures:

FIG. 1 is a block diagram of an electronic device including a microcontroller to control a timing controller using pulse width modulated (PWM) signals, in accordance with various examples.

FIG. 2 is a block diagram of an electronic device including a microcontroller to control a timing controller using PWM signals, in accordance with various examples.

FIG. 3 is a block diagram of an electronic device including a microcontroller to control a timing controller using PWM signals, in accordance with various examples.

FIGS. 4-9 are timing diagrams depicting pulse width modulation (PWM) signals in accordance with various examples.

### DETAILED DESCRIPTION

Many electronic devices include timing controllers (TCONs) that control the manner in which a display panel (e.g., a liquid crystal display panel (LCD)) is illuminated. For example, a TCON may control the timing with which display panel elements in a display panel are driven. A TCON controls a display panel based on various inputs that the TCON receives. One such input is received from a graphics processing unit (GPU), because many computer architectures include a direct auxiliary channel between the GPU and the TCON. Using this direct auxiliary channel, the GPU is able to control the TCON, including instructing the TCON regarding specific brightness levels and refresh rates with which the display panel is to be illuminated, as well as screen savers, logos, warning messages, etc., that are to be displayed on the display panel. In some cases, it may be desirable from an architectural design standpoint to have a computer component other than the GPU control the TCON. For example, it may be desirable to have an embedded controller (EC) (e.g., a microcontroller) control the TCON. However, having an EC or other components control the TCON entails the addition of expensive and space-consuming hardware, such as I2C buses, UARTs, GPIOs, etc.

This disclosure describes various examples of an electronic device, such as a laptop computer, a desktop computer, a notebook computer, a tablet, a television, etc., that facilitates direct communication between an EC and a TCON, thereby mitigating the use of expensive and space-consuming hardware, such as I2C buses, UARTs, GPIOs, etc. Specifically, a brightness control bus (BCB) is coupled to the EC and to the TCON, and the EC encodes patterns into a pulse width modulated (PWM) signal on the BCB. The TCON receives the encoded PWM signal, decodes the PWM signal to identify a pattern, and performs one or more actions based on the identified pattern. The TCON measures the time duration of the pattern to determine whether the pattern is a brightness control instruction or an alternative control instruction, and the TCON acts accordingly. Although this description assumes that an EC controls the TCON, any of a variety of other components in a computer other than the GPU may couple in a similar manner to the TCON and send encoded messages to the TCON as described herein.

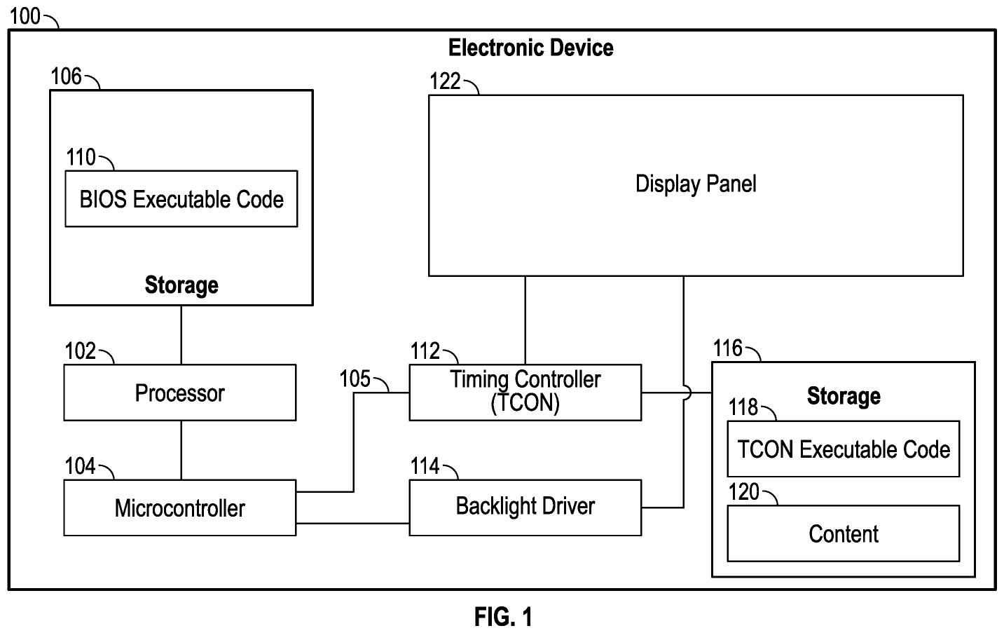

FIG. 1 is a block diagram of an electronic device 100 including a microcontroller to control a TCON using PWM signals, in accordance with various examples. The electronic device 100 may be a laptop computer, desktop computer, tablet, notebook, smartphone, television, appliance (e.g., washer, dryer, or refrigerator having a display), etc. More generally, the electronic device 100 includes any device having a display panel controlled at least in part by a TCON. In examples, the electronic device 100 includes a processor 102, a microcontroller 104 (e.g., an embedded controller), storage 106 (e.g., random access memory, read-only memory) storing basic input output system (BIOS) executable code 110. The processor 102 executes the BIOS executable code 110. As used herein, a basic input/output system (BIOS) refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of computing device.

In some examples, a BIOS may provide or establish an interface between hardware devices or platform firmware of the computing device and an OS of the computing device, via which the OS of the computing device controls or operates hardware devices or platform firmware of the computing device. In some examples, the Unified Extensible Firmware Interface (UEFI) specification or another specification or standard is used for initializing, controlling, or operating a computing device.

Referring again to FIG. 1, the electronic device 100 also includes a TCON 112, a backlight driver 114, storage 116 (e.g., random access memory, read-only memory) storing TCON executable code 118 and content 120 (e.g., screen savers, warning messages, logos, etc.), and a display panel 122 (e.g., a liquid crystal display panel (LCD), an organic light-emitting diode (OLED) display). The microcontroller 104 is coupled to the processor 102, which is coupled to the storage 106. The microcontroller 104 is also coupled to the TCON 112 by a bus 105, via which the microcontroller 104 provides backlight brightness control signals to the TCON 112. The microcontroller 104 further is coupled to the backlight driver 114, which, in turn, is coupled to the display panel 122. The TCON 112 is coupled to the storage 116 and the display panel 122.

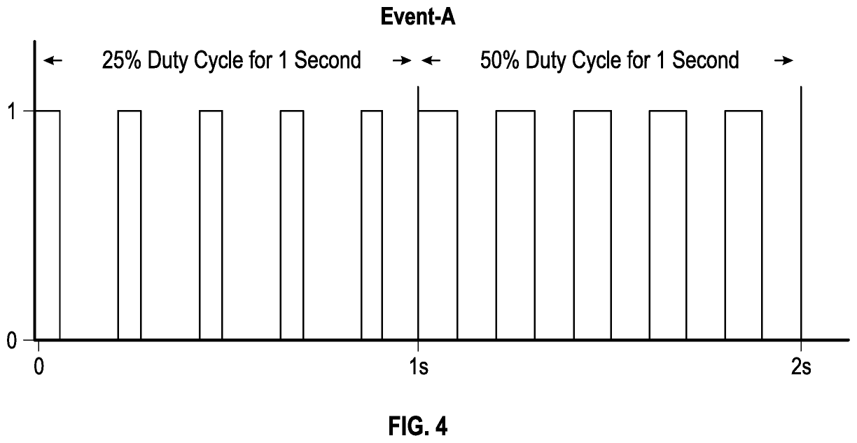

In operation, the microcontroller 104 enables the backlight power of the display panel 122 by providing a backlight power enable signal to the backlight driver 114. For example, when the backlight power enable signal is high, the backlight driver 114 drives the backlight of the display panel 122, and when the backlight power enable signal is low, the backlight driver 114 does not drive the backlight of the display panel 122. When the backlight of the display panel 122 is off, the TCON 112 is not expecting to receive any backlight brightness control signals from the microcontroller 104 on the bus 105. Accordingly, while the backlight of the display panel 122 is off, the microcontroller 104 may communicate any type of information to the TCON 112. However, when the backlight of the display panel 122 is on, the TCON 112 expects to receive backlight brightness control signals from the microcontroller 104 on the bus 105. Accordingly, the microcontroller 104 provides brightness control signals to the TCON 112 via the bus 105, but the microcontroller 104 also provides other types of information and commands to the TCON 112 via the bus 105, and thus the microcontroller 104 differently encodes brightness and non-brightness commands in the signals provided to the TCON 112 via the bus 105 such that the TCON 112 can distinguish the brightness commands from the non-brightness commands. More particularly, the microcontroller 104 provides a PWM signal to the TCON 112 via the bus 105, and the microcontroller 104 encodes different patterns in the PWM signal by manipulating a duty cycle of the PWM signal and a duration of the duty cycle. The TCON 112 receives the PWM signal, decodes the patterns, and controls brightness and/or non-brightness features of the display panel 122 based on the patterns. Examples of such patterns are provided below with reference to FIGS. 4-9. In examples, the microcontroller 104 generates such PWM signals independently of other processors and/or controllers in the electronic device 100. In other examples, the microcontroller 104 generates such PWM signals based on instructions received from the processor 102 upon executing the BIOS executable code 110. In examples, the microcontroller 104 generates such PWM signals in response to a particular sequence of keystrokes or other inputs entered by a user.

The TCON 112 performs the actions attributed herein to the TCON 112 at least in part by executing the TCON executable code 118. The TCON 112 controls brightness features of the display panel 122 by increasing the brightness of the display panel 122, decreasing the brightness of the display panel 122, or maintaining a brightness of the display panel 122. The TCON 112 controls non-brightness features of the display panel 122, for example, by displaying textual and/or graphical content on the display panel 122. For example, the TCON 112 may cause logos, warning messages, or screen savers to appear on the display panel 122, and the TCON 112 may obtain such textual and/or graphical content from the content 120 on storage 116.

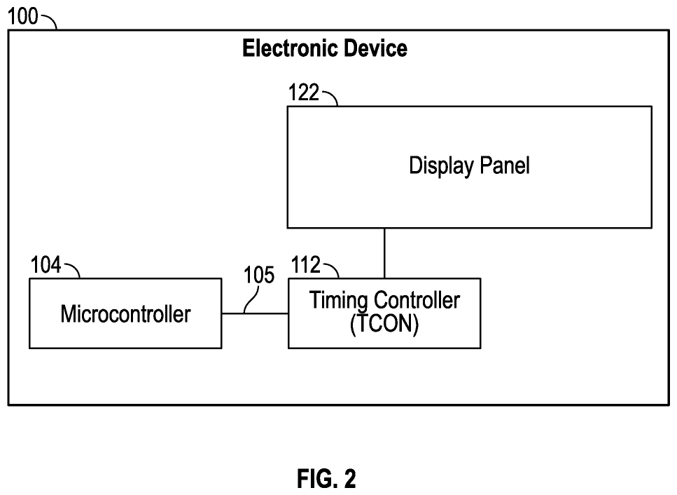

FIG. 2 is a block diagram of another example of the electronic device 100. The electronic device 100 includes at least the TCON 112 coupled to the display panel 122 and to the microcontroller 104 by way of the bus 105. The operation of the electronic device 100 as depicted in FIG. 2 is similar to that of FIG. 1 and thus is not repeated here.

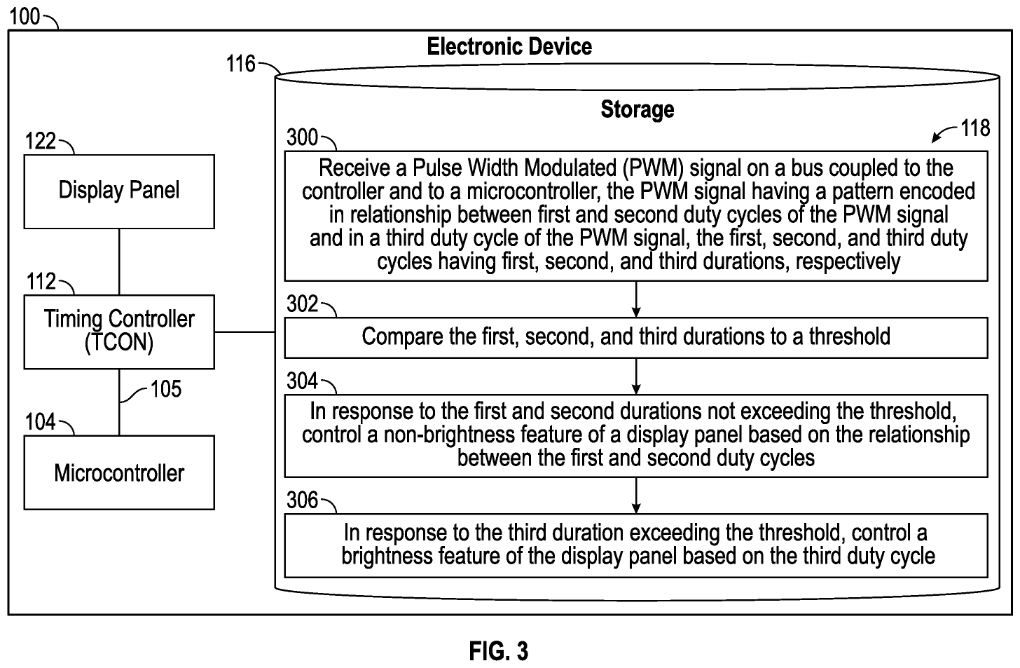

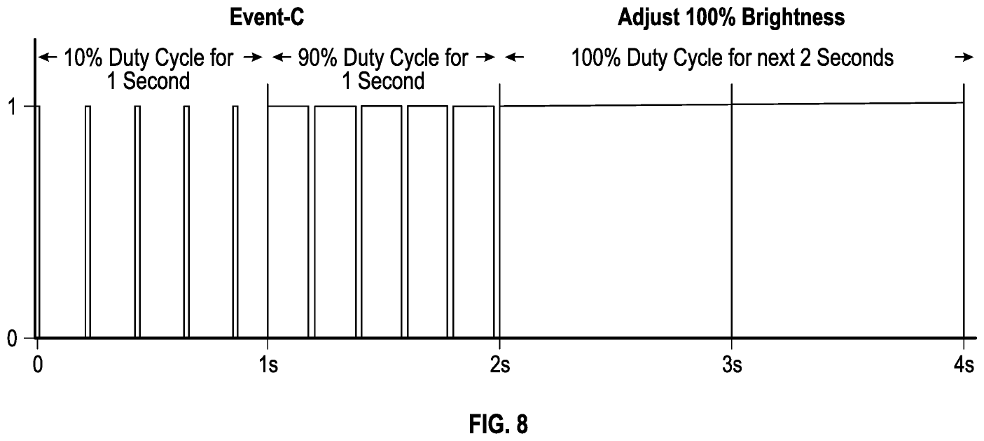

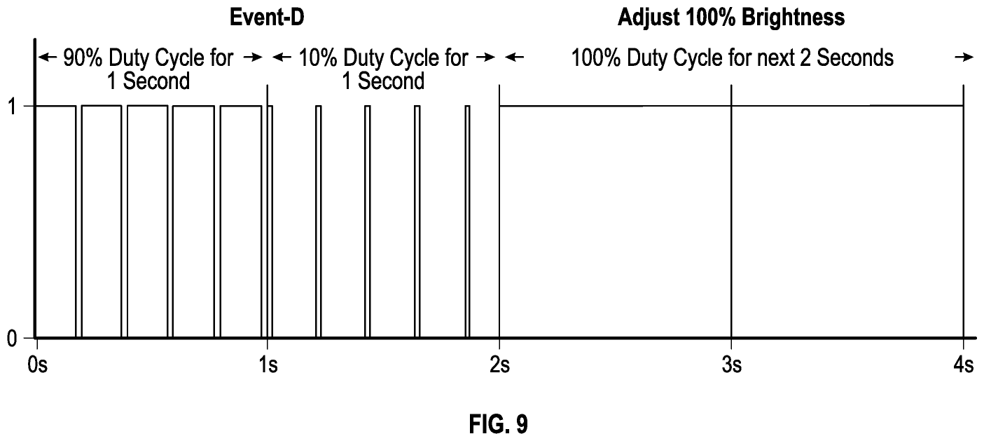

FIG. 3 is a block diagram of another example of the electronic device 100. The electronic device 100 includes at least the TCON 112 coupled to the display panel 122 and to the microcontroller 104 via the bus 105. The TCON 112 is also coupled to the storage 116 including TCON executable code 118. The storage 116 may be a non-transitory computer-readable medium, where the term “non-transitory” does not encompass transitory propagating signals. The TCON 112, upon executing the TCON executable code 118, performs the following actions. The TCON 112 receives a PWM signal on the bus 105 coupled to the TCON 112 and to the microcontroller 104. The PWM signal has a pattern encoded in a relationship between first and second duty cycles of the PWM signal and in a third duty cycle of the PWM signal. The first, second, and third duty cycles have first, second, and third durations, respectively (300). The TCON 112 compares the first, second, and third durations to a threshold (302). The TCON 112, in response to the first and second durations not exceeding the threshold, controls a non-brightness feature of the display panel 122 based on the relationship between the first and second duty cycles (304). The TCON 112, in response to the third duration exceeding the threshold, controls a brightness feature of the display panel 122 based on the third duty cycle (306). The steps 300, 302, 304, and 306 are described in greater detail below with reference to FIGS. 8 and 9.

FIG. 4 is a timing diagram depicting pulse width modulation (PWM) signals provided by the microcontroller 104 on the bus 105 to the TCON 112, in accordance with various examples. The x-axis depicts time in seconds and the y-axis depicts a voltage state (e.g., a low or “0” state and a high or “1” state). FIG. 4 depicts a pattern that includes specific duty cycles of the PWM signal provided for specific durations of time. The TCON 112, upon detecting such a pattern, performs an action (e.g., displaying a particular image on the display panel 122). In the example of FIG. 4, for a duration of one second (Os to 1s), the PWM signal includes a 25% duty cycle and, for a duration of one second (1s to 2s), the PWM signal includes a 50% duty cycle. The specific pattern (the specific duty cycles and specific durations) may vary in examples, and any combination of duty cycles and durations may be used as long as the TCON executable code 118 has been programmed to cause the TCON 112 to recognize the pattern.

In examples, the TCON 112 uses the duration of a particular duty cycle to distinguish whether that duty cycle is to be used to adjust a brightness feature of the display panel 122 or if it is to be used to adjust a non-brightness feature (e.g., display a particular textual or graphical content) of the display panel 122. For example, the threshold may be 1.5 seconds, meaning that the TCON 112 interprets any duty cycle having a duration less than 1.5 seconds as relating to a non-brightness feature, and any duty cycle having a duration greater than 1.5 seconds as relating to a brightness feature. In examples, the threshold is 1 second. In examples, the threshold is 2 seconds. Other thresholds are contemplated and included in the scope of this disclosure. In the example of FIG. 4, because the two duty cycles fall below the example threshold of 1.5 seconds, the TCON 112 interprets the duty cycles as being instructive of an action (“Event A”) to adjust a non-brightness feature of the display panel 122, with the specific action to be performed based on the duty cycle pattern. For instance, the storage 116 may store a table that cross-references the duty cycle pattern of 25% and 50% with an action, such as displaying a screen saver on the display panel 122.

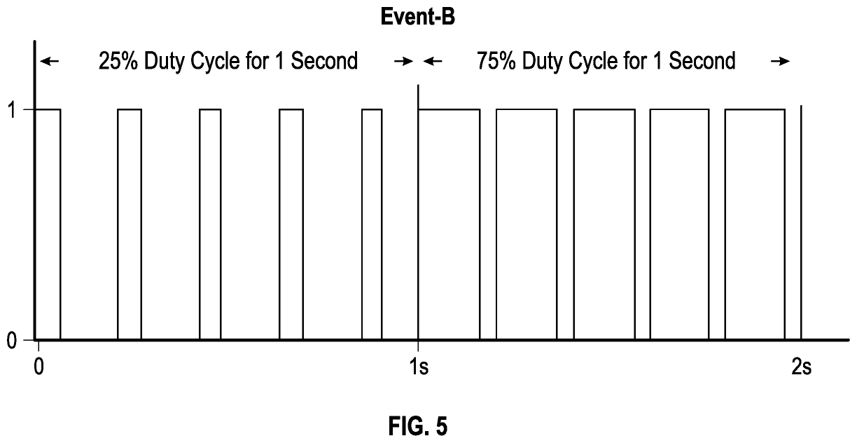

FIG. 5 is a timing diagram depicting pulse width modulation (PWM) signals provided by the microcontroller 104 on the bus 105 to the TCON 112, in accordance with various examples. The x-axis depicts time in seconds and the y-axis depicts a binary voltage state (e.g., a low or “0” state and a high or “1” state). FIG. 5 depicts a pattern that includes specific duty cycles of the PWM signal provided for specific durations of time. The TCON 112, upon detecting such a pattern, performs an action (e.g., displaying a particular image on the display panel 122). In the example of FIG. 5, for a duration of one second (Os to 1s), the PWM signal includes a 25% duty cycle and, for a duration of one second (1s to 2s), the PWM signal includes a 75% duty cycle. Because the durations of the duty cycles are under the example threshold of 1.5 seconds, the TCON 112 determines which action (“Event B”) corresponds to the duty cycle pattern of 25% followed by 75% and performs that action accordingly.

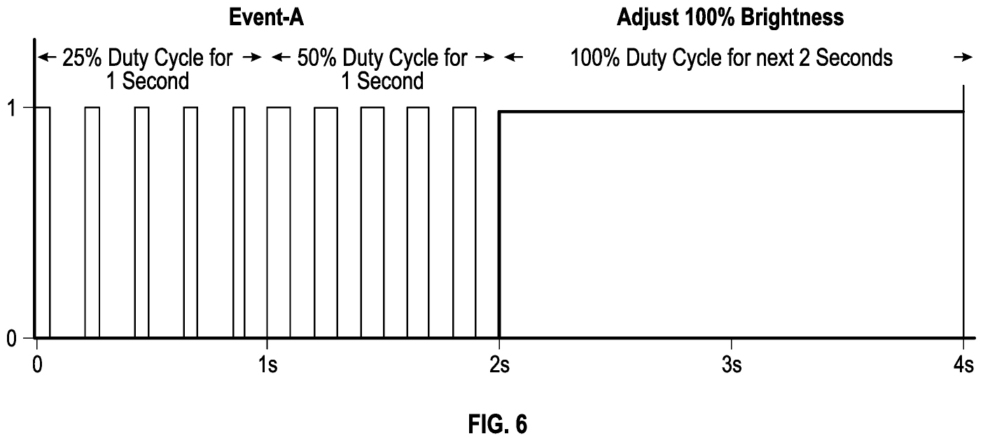

FIG. 6 is a timing diagram depicting pulse width modulation (PWM) signals provided by the microcontroller 104 on the bus 105 to the TCON 112, in accordance with various examples. The x-axis depicts time in seconds and the y-axis depicts a binary voltage state (e.g., a low or “0” state and a high or “1” state). FIG. 6 depicts a pattern that includes specific duty cycles of the PWM signal provided for specific durations of time. The TCON 112, upon detecting such a pattern, performs an action (e.g., displaying a particular image on the display panel 122). In the example of FIG. 4, for a duration of one second (Os to 1s), the PWM signal includes a 25% duty cycle; for a duration of one second (1s to 2s), the PWM signal includes a 50% duty cycle; and for a duration of two seconds (2s to 4s), the PWM signal includes a 100% duty cycle. Upon receipt of the PWM signal encoded with this pattern, the TCON 112 compares the durations of the first, second, and third duty cycles to the example threshold of 1.5 seconds and determines that the first and second duty cycles, each having a duration less than 1.5 seconds, correspond to an action (“Event A”) to be performed on a non-brightness feature of the display panel 122 and the third duty cycle, having a duration of greater than 1.5 seconds, corresponds to an action to be performed on a brightness feature of the display panel 122.

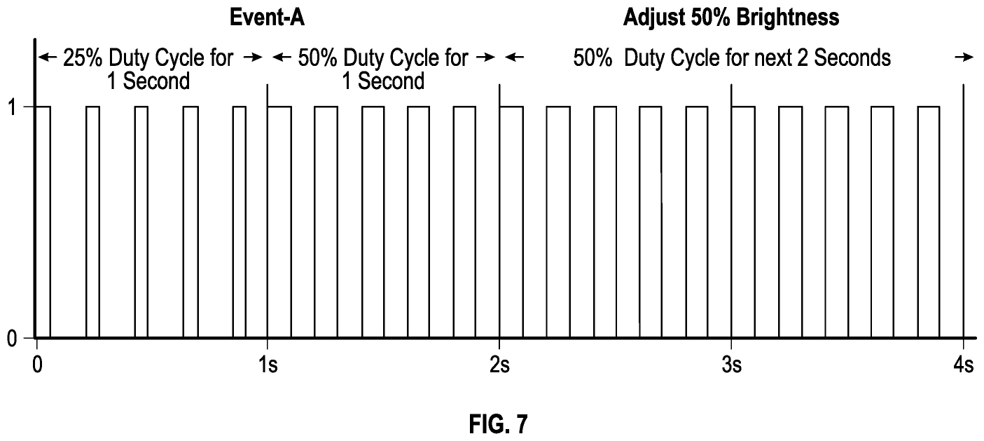

The timing diagram of FIG. 7 is identical to that of FIG. 6, except that the third duty cycle is 50% instead of 100%. Thus, the TCON 112 performs an action (“Event A”) on a non-brightness feature of the display panel 122 that corresponds to a duty cycle pattern of 25% followed by 50%, and the TCON 112 then adjusts the brightness of the display panel 122 to 50% of the maximum possible brightness of the display panel 122.

The timing diagram of FIG. 8 is identical to that of FIG. 6, except that the first and second duty cycles have a pattern of 10% followed by 90%. Stated another way, the first and second duty cycles have a pattern of n % followed by 100%-n %, meaning that the two duty cycles add up to 100%. This is referred to as a contrast pattern, and upon receipt of such a contrast pattern in which the two duty cycles add up to 100%, the TCON 112 performs a corresponding action (“Event C”) on a non-brightness feature of the display panel 122. In examples, three or more duty cycles may be used in the PWM signal, and in such cases, a contrast pattern would still add up to a total of 100%.

In some examples, a contrast duty cycle pattern may be negative or positive, with negative contrast patterns corresponding to a first action on a non-brightness feature of the display panel 122, and with positive contrast patterns corresponding to a second action on a non-brightness feature of the display panel 122. A positive contrast pattern is one in which a first duty cycle is n % followed by 100%-n %, where n is less than 50. For example, the pattern in FIG. 8 is a positive contrast pattern and causes the TCON 112 to perform Event C. A negative contrast pattern is one in which a first duty cycle is n % followed by 100%-n %, where n is greater than 50. For example, the pattern in FIG. 9 (which depicts a timing diagram identical to that of FIG. 8 except that the duty cycles pattern is 90% followed by 10%) has a negative contrast pattern, and thus causes the TCON 112 to perform Event D.

In examples, prior to manipulating the PWM signal on the bus 105 as described herein, the microcontroller 104 stores an indicator of an existing brightness level (e.g., in a register) of the display panel 122. After commanding the TCON 112 to perform one or more actions on non-brightness features of the display panel 122, the microcontroller 104 provides a PWM signal on the bus 105 using the stored indicator that restores the stored brightness level to the display panel 122.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

1. An electronic, device, comprising:
a bus;
a microcontroller coupled to the bus, the microcontroller to:
encode a pattern in a pulse width modulated (PWM) signal by manipulating a duty cycle of the PWM signal and a duration of the duty cycle; and
provide the PWM signal on the bus;
a display panel; and
a timing controller (TCON) coupled to the display panel and to the microcontroller via the bus, the ICON to control a brightness feature and a non-brightness feature of the display panel based on the pattern encoded in the PWM signal, wherein the brightness feature comprises increasing, decreasing, or maintaining brightness of the display panel, and wherein the non-brightness feature comprises an action to adjust a feature of the display panel other than the brightness feature.

2. The electronic device of claim 1, wherein the TCON is to:
in response to the PWM signal including a first duty cycle for a first duration of time followed by a second duty cycle for a second duration of time, perform a first action.

3. The electronic device of claim 2, wherein the TCON is to:
in response to the PWM signal including a third duty cycle for a third duration of time, perform a second action.

4. The electronic device of claim 3, wherein, in response to the first and second durations of time falling below a threshold, the first action includes adjusting the non-brightness feature of the display panel, and in response to the third duration of time exceeding the threshold, the second action includes adjusting the brightness feature of the display panel.

5. The electronic device of claim 1, wherein the microcontroller is to encode the pattern in the PWM signal and provide the PWM signal on the bus in response to detection of a keystroke sequence.

6. The electronic device of claim 1, wherein the TCON is to:
in response to the PWM signal including a first duty cycle followed by a second duty cycle, the first duty cycle greater than the second duty cycle, the first and second duty cycles adding to 100%, performing a first action to control the non-brightness feature.

7. The electronic device of claim 6, wherein the TCON is to:
in response to the PWM signal including a third duty cycle followed by a fourth duty cycle, the third duty cycle less than the fourth duty cycle, the third and fourth duty cycles adding up to 100%, performing a second action to control the non-brightness feature, the second action different from the first action.

8. The electronic device of claim 1, wherein the non-brightness feature includes content displayed on the display panel.

9. The electronic device of claim 1, wherein the microcontroller is to store an existing brightness level of the display panel, and wherein the microcontroller is to encode the PWM signal to indicate the brightness level.

10. An electronic device, comprising:
a bus;
a microcontroller coupled to the bus, the microcontroller to:
encode a pattern in a pulse width modulated (PWM) signal by manipulating a duty cycle of the PWM signal and a duration of the duty cycle; and
provide the PWM signal on the bus;
a display panel; and
a timing controller (TCON) coupled to the display panel and to the microcontroller via the bus, the ICON to:
control a brightness feature of the display panel according to the duty cycle and in response to the duration exceeding a threshold; and
control a non-brightness feature of the display panel according to the duty cycle and in response to the duration not exceeding the threshold,
wherein the brightness feature comprises increasing decreasing, or maintaining brightness of the display panel, and wherein the non-brightness feature comprises an action to adjust a feature of the display panel other than the brightness feature.

11. The electronic device of claim 10, wherein the TCON is to:
in response to the PWM signal including a first duty cycle n % for a first duration of time and a second duty cycle 100%-n % for a second duration of time, perform an action.

12. The electronic device of claim 11, whereinthe TCON is to perform the action only if n % is greater than 100%-n %.

13. The electronic device of claim 11, wherein the TCON is to perform the action only if n % is less than 100%-n %.

14. The electronic device of claim 10, wherein the microcontroller is to store an indicator of an existing brightness level of the display panel, and, after providing the PWM signal on the bus to cause the TCON to perform an action, adjust the duty cycle and the duration to restore the existing brightness level to the display panel using the indicator.

15. The electronic device of claim 10, wherein the microcontroller is to encode the pattern in the PWM signal and provide the PWM signal on the bus in response to detection of a keystroke sequence.

16. A non-transitory computer-readable medium storing exec table code, which, when executed by a controller, cause the controller to:
receive a pulse width modulated (PWM) signal on a bus coupled to the controller and to a microcontroller, the PWM signal having a pattern encoded in a relationship between first and second duty cycles of the PWM signal and m a third duty cycle of the PWM signal, the first, second, and third duty cycles having first, second, and third durations, respectively;
compare the first, second, and third durations to a threshold;
in response to the first and second durations not exceeding the threshold, control a non-brightness feature of a display panel based on the relationship between the first and second duty cycles; and
in response to the third duration exceeding the threshold, control a brightness feature of the display panel based on the third duty cycle
wherein the brightness feature comprises increasing, decreasing, or maintaining brightness of the display panel, and wherein the non-bri htness feature comprises an action to adjust a feature of the display panel other than the brightness feature.

17. The non-transitory medium of claim 16, wherein the first duty cycle is n % and the second duty cycle is 100%-n %.

18. The non-transitory medium of claim 16, wherein the first duty cycle is 100%-n % and the second duty cycle is n %.

19. The non-transitory medium of claim 16, wherein the non-brightness features include the display of logos, warning messages, and screen savers on the display panel.

20. The non-transitory medium of claim 16, wherein the pattern is based on a keystroke sequence input by a user.
